(19) United States
(12) Patent Application Publication
(10) Pub. No.: US 2015/0154433 A1
(43) Pub. Date: Jun. 4, 2015

(54) RFID MOLDED CONNECTOR TRACKING SYSTEM AND METHOD

(71) Applicant: Integro LLC, New Britain, CT (US)

(72) Inventor: Tara Stewart, Bristol, CT (US)

(73) Assignee: Integro LLC, New Britain, CT (US)

(21) Appl. No.: 14/500,127

(22) Filed: Sep. 29, 2014

Related U.S. Application Data
(60) Provisional application No. 61/883,674, filed on Sep. 27, 2013.
(60) Provisional application No. 61/942,339, filed on Feb. 20, 2014.

(51) Int. Cl. G06K 7/10

(52) U.S. Cl. CPC G06K 7/10366

(57) ABSTRACT

A Radio Frequency Identification (“RFID”) tracking system includes an electrical connector and an RFID transponder is disposed within the connector. The transponder configured to transmit a first signal to a transmitting and receiving device and receive a second signal from the transmitting and receiving device.

### CROSS-REFERENCE TO RELATED APPLICATION

This application claims the benefit of U.S. Provisional Patent Application Ser. No. 61/883,674 filed on Sep. 27, 2013, and U.S. Provisional Patent Application Ser. No. 61/942,339 filed on Feb. 20, 2014,which applications are incorporated herein by reference in their entirety:

### TECHNICAL FIELD

The present invention is directed to a system and method for identifying, tracking and managing the life cycle of electrical assets such as for example electrical components related to power supply and lighting. More particularly, the present invention is directed to a Radio Frequency Identification (“RFID”) System for identifying such electrical assets, and tracking and managing related life cycle information such as maintenance and warranty information.

### BACKGROUND

The use of RFID was introduced during World War II by the British to differentiate friend and foe aircraft. Since that time, RFID has been used in a wide variety of applications. Today's applications include but are not limited to identifying and tracking the movement of containers, protecting goods from shoplifting, reducing the counterfeiting of pharmaceuticals and medicines, and improving baggage handling and tracking books in libraries.

Generally speaking, an RFID System includes one or more tags or transponders and a Reader. The Reader has the capability to read multiple tags at a time which are in range of the Reader. The markets defined above include applications exposed to a variety of rugged environments and thus require a permanently fixed identification or tag capable of surviving harsh environmental conditions and rough handling. In addition, each such a fixed tag requires a unique data set for identifying and tracking the respective electrical asset for managing related life cycle information such as maintenance and warranty information.

For example, airport lighting requires warranty tracking of certain electrical assets when transitioning from incandescent technology to light emitting diode (“LED”) technology. The U.S. Federal Aviation Administration (“FAA”) mandates that all certified LED airfield lighting products carry a four year warranty. As a result, such LED airfield lighting products require a permanently fixed identification or tag capable of surviving harsh environmental conditions and rough handling for identifying and tracking the respective electrical asset for managing the related maintenance and warranty information.

Accordingly, the inventors have recognized that the RFID molded connector tracking system and method of the present invention provides a solution for identifying and tracking respective electrical assets for managing related life cycle information such as maintenance and warranty information for both the original equipment manufacturer (“OEM”) and the end user.

### SUMMARY

In one aspect, the present invention resides in an RFID tracking system comprising: an electrical connector; and an RFID transponder disposed within the connector, the transponder configured to transmit a first signal to a transmitting and receiving device and receive a second signal from the transmitting and receiving device.

In another aspect, the present invention resides in a method for identifying an electrical asset and managing maintenance and warranty information of the electrical asset, the method comprising: imbedding an RFID transponder in a connector in communication with an electronic device; transmitting a first signal to the imbedded RFID transponder; and receiving a second signal from the RFID transponder.

### BRIEF DESCRIPTION OF THE DRAWINGS

FIG. 1 provides an isometric view of one embodiment of a connector having an RFID tag imbedded therein in accordance with the present invention.

FIG. 1a provides an isometric view of one embodiment of an RFID tag imbedded for the purposes of external attachment to assets therein in accordance with the present invention.

FIG. 2 is a top view of the connector of FIG. 1 having an RFID tag imbedded therein.

FIG. 3 is a cross-section view of the connector of FIG. 1 having an RFID tag imbedded therein, the cross-section taken along line A-A of FIG. 2.

FIG. 4 is a block diagram of one embodiment of an RFID Tracking System in accordance with the present invention.

FIG. 5 is a block diagram of another embodiment of an RFID Tracking System in accordance with the present invention.

### DETAILED DESCRIPTION

An RFID molded connector tracking system and method of the present invention provides a solution for identifying and tracking respective electrical assets for managing related life cycle information such as maintenance and warranty information for both the OEM and the end user. The RFID molded connector tracking system of the present invention is designed and configured to operate in and withstand rugged environments which contribute to excessive wear of selected and identified electrical assets. Such rugged environments include, for example: substantially high temperatures; substantially low temperatures; temperature fluctuations from a substantially high temperature to a substantially low temperature; substantially high pressures; moisture and/or humidity; dirt, dust, and debris; trampling by pedestrians and/or passing over by heavy objects such as vehicles, airplanes, construction equipment, and the like; and substantial vibration such as in connection with containers being transported by vehicles, airplanes, trains, vessels and the like.

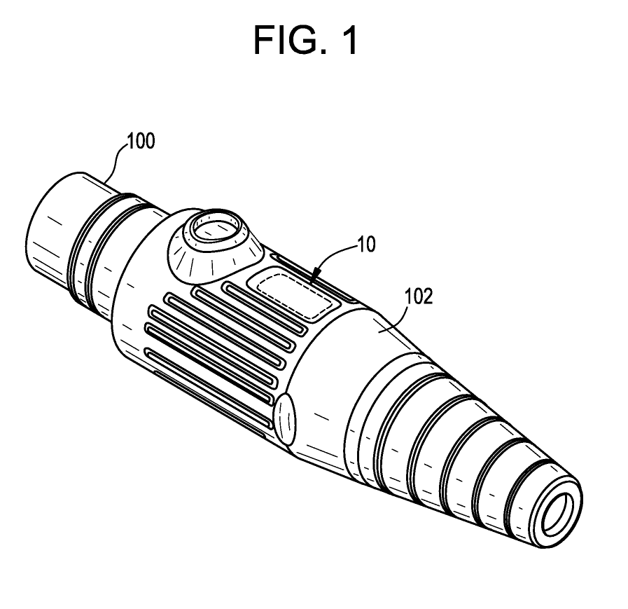

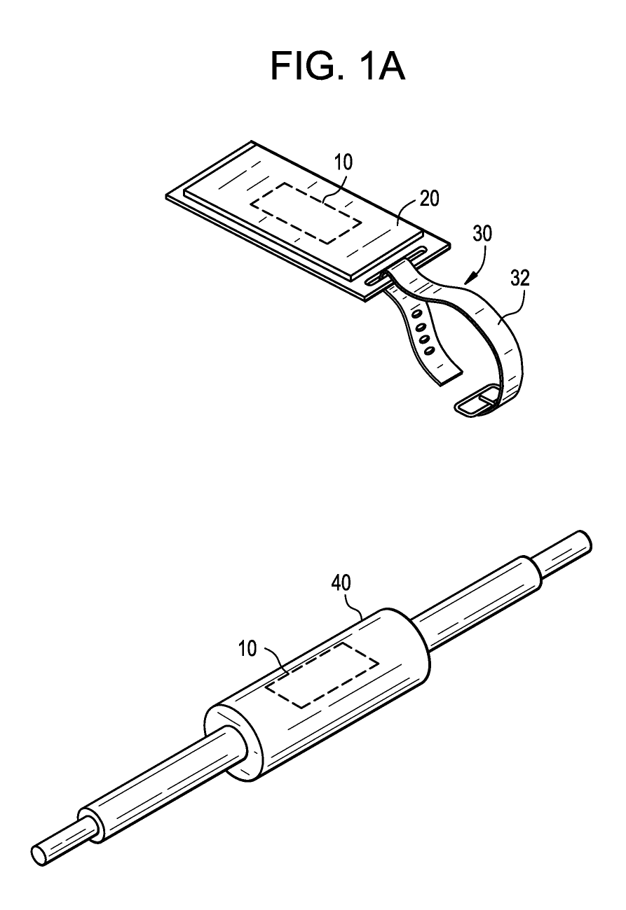

As shown in FIGS. 1 and 2, a permanently molded RFID transponder or tag 10 is used as the building block for an RFID Tracking System. The rugged tag 10 is molded into a connector 100 below an exterior surface 102 of the connector 100. Several embodiments of a suitable connector are illustrated and discussed in U.S. patent application Ser. No. 13/770,274 (published as U.S. Patent Application Publication No. 2013/0217257), filed on Feb. 19, 2013, which patent application is incorporated by reference here in its entirety. Additional embodiments of a suitable connector are illustrated and discussed in U.S. patent application Ser. No. 13/758,542 (published as US Patent Application Publication No. 2013/0201658), filed on Feb. 4, 2013, which patent application is incorporated by reference here in its entirety. While one tag 10 is shown and described as imbedded within connector 100 beneath surface 102, the present invention is not limited in this regard as more than one tag 10 can be imbedded within connector 100 beneath surface 102 without departing from the broader aspects of the present invention.

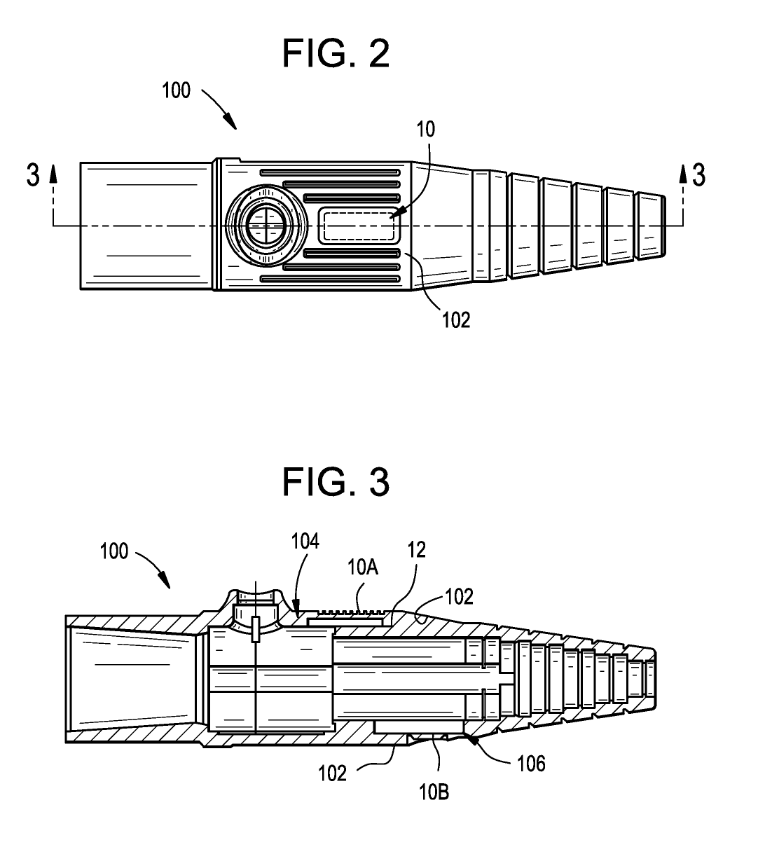

As shown in FIG. 3, one embodiment of connector 100 includes a tag 10A imbedded therein beneath surface 102 at a location 104 of connector 100. While tag 10A is shown and described as imbedded within connector 100 beneath surface 102 at location 104, the present invention is not limited in this regard as a tag 10 can be imbedded within connector 100 beneath surface 102 at any suitable location, such as for example tag 10B imbedded at a location 106, without departing from the broader aspects of the present invention. Optionally, a metallic foil 12 is used on the back side of the RFID tag 10A to maximize the communication range.

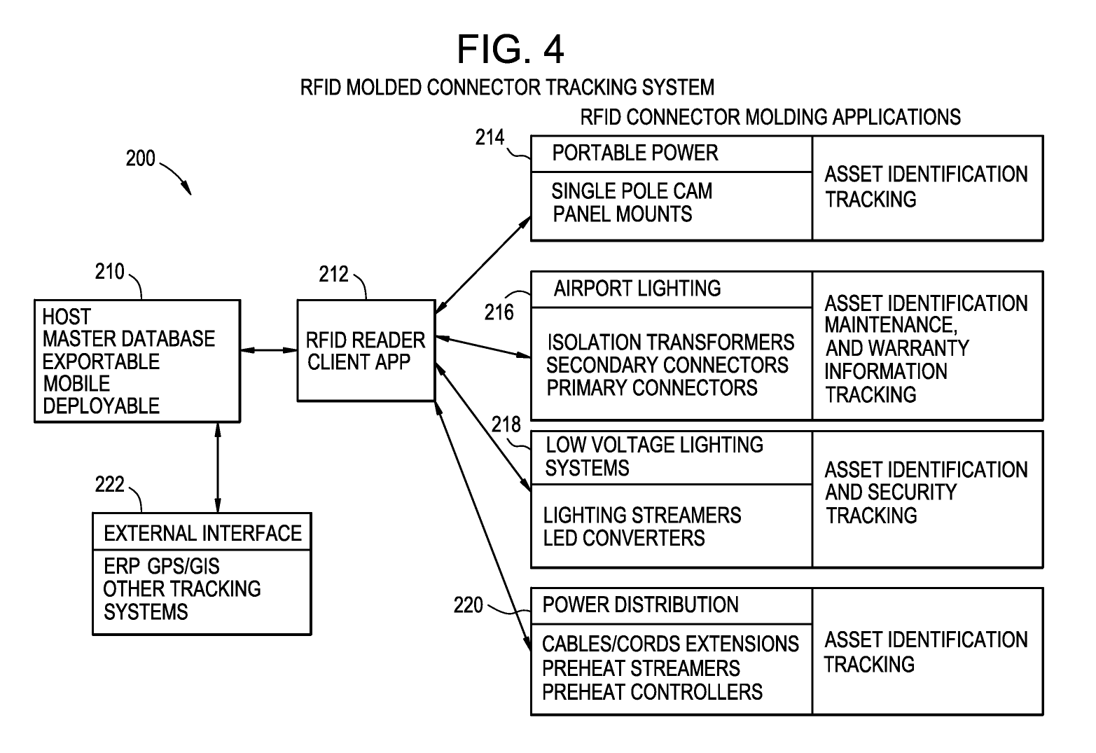

As shown in FIG. 4, one embodiment of an RFID Tracking System 200 of the present invention includes a host server 210 as further described below. The RFID tag 10 selectively comprises a transponder that communicates with a transmitting and receiving portable adaptive device such as an RFID reader 212 having a processor and a customizable interface enabled with an application configured for an intended use such as, for example, portable power 214, airport lighting 216, low voltage lighting systems 218, and power distribution 220, as further described below. In one embodiment, the RFID reader is a hand-held reader and/or scanner. In one embodiment, a plurality of RFID tags 10 are concurrently read and/or scanned by the RFID reader 212. In such an embodiment, the RFID reader 212 includes at least one antenna or an antenna raceway system designed to concurrently read the plurality of RFID tags 10 that, for example, are bundled together and packaged on a skid of electrical assets respectively having the RFID tag imbedded therein.

In the field of providing portable power, the RFID tag 10 is used to identify and track related portable power assets such as, for example, Series 16, 18, 22 & 23 Single Pole Connectors and Panel Mounts. In one embodiment, the RFID tag 10 is molded into the connectors and panel mounts for tracking of generators, power distribution boxes and cables. The RFID tag 10 identifies and tracks certain life cycle information and data of the connectors and panel mounts including but not be limited to: manufacturer; lessor; lessee; date manufactured; part number; description; serial number; location; last scanned date; and last scanned location.

In the field of airfield lighting, the RFID tag 10 is used to identify and track related airfield lighting assets such as isolation transformers, secondary and primary connectors, lighting fixtures, signs, primary circuits and other airfield lighting assets. In one embodiment, the RFID tag 10 is molded into connectors and/or attachable identifiers or shrouds for tracking of such airfield lighting assets. In one embodiment, the RFID tag 10 is molded directly into a transformer. The RFID tag 10 identifies and tracks certain life cycle information and data of the airfield lighting assets including but not be limited to: manufacturer; date manufactured; date installed; warranty end date; type (isolation transformer, fixture, and or primary circuit); part number (type); serial number; location (Global Positioning System (“GPS”) coordinates, circuit/fixture identifier, pit/can identifier/circuit, etc.); maintenance date (1); maintenance description (1); maintenance date (2); maintenance description (2); maintenance date (3); maintenance description (3); maintenance date (x); maintenance description (x); etc.

In the field of low voltage lighting, the RFID tag 10 is used to identify and track related low voltage lighting assets such as power connectors (e.g., Style 1, Style 7 and U-Ground Connectors), low voltage LED converters, lighting streamers, T8 fixtures, hand lights, task lights, trouble lights, lamp holders and explosion proof/vapor proof lights. In one embodiment, the RFID tag 10 is molded into connectors and/or attachable identifiers or shrouds for tracking of such low voltage lighting assets. The RFID tag 10 identifies and tracks certain life cycle information and data of the low voltage lighting assets including but not be limited to: manufacturer; lessor; lessee; date manufactured; part number; description; serial number; location; last scanned date; and last scanned location.

In the field of power distribution, the RFID tag 10 is used to identify and track related low power distribution assets such as power connectors and outlets including all industry standard connectors (e.g., 4M50, 4F50, 4M20, 4F20, 4MJ20, 4FJ20, 3M50, 3F50, 4F20, 3F20, 3MT20, 3FT20, 15FR, Dinse style and Palmgren type), Twist Lock NEMA L type plugs, Straight NEMA Type plugs, power distribution blocks, power strips, connectors (straight blade, locking and pin/sleeve), and panel mounts (P) and yokes (multiple inputs and outputs). In one embodiment, the RFID tag 10 is molded into connectors and/or attachable identifiers or shrouds for tracking of such power distribution assets. The RFID tag 10 identifies and tracks certain life cycle information and data of the low voltage lighting assets including but not be limited to: manufacturer; date manufactured; date installed; warranty end date; type (isolation transformer, fixture, and or primary circuit); part number (type); serial number; location (GPS coordinates, circuit/fixture identifier, pit/can identifier /circuit, etc.).

In one embodiment of the RFID tag 10, data is stored therein. In one embodiment of the RFID tag 10, the RFID tag 10 is associated with data in a master database stored in, for example, an end user's server located at the end user's site. Data is updated with each scan of the RFID tag 10 wherein such updated data includes but is not limited to location, last scan date, and as further described above with respect to particular applications. Data is obtained from or read from the RFID tag 10 wherein such readable data includes but is not limited to warranty end date, and as further described above with respect to particular applications. Data is added/modified as certain triggers occur such as a maintenance repair, change in lessee, and as further described above with respect to particular applications.

Data fields are established for receiving, storing and transmitting data maintained in the RFID tag 10. Such data fields are configurable as needed are virtually unlimited when stored in a master database and referenced by the RFID tag 10.

In one embodiment, the transmission range for receiving and transmitting data maintained in the RFID tag 10 is up to about twenty (20) feet, and more particularly in the range of about fifteen (15) to about twenty (20) feet, for passive tags with proximity technology to be able to differentiate between multiple tags in the same location.

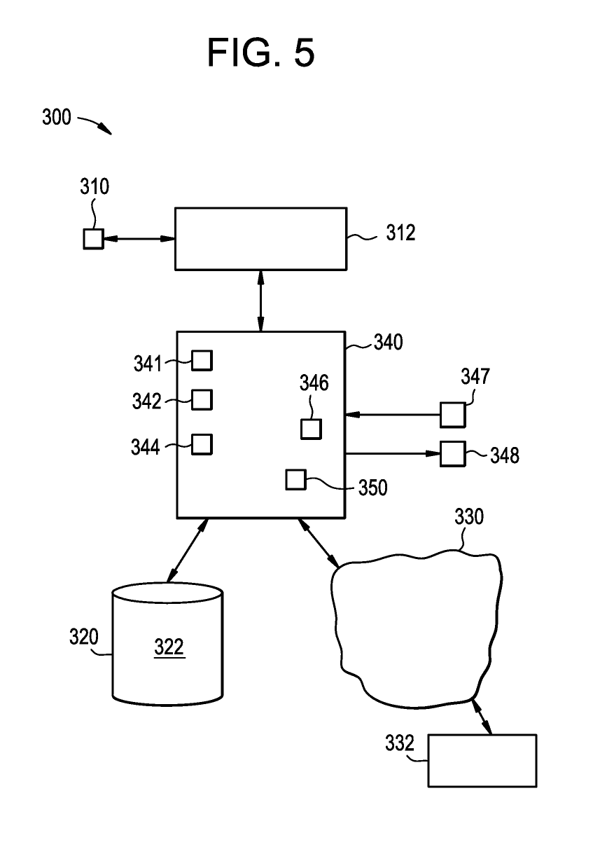

As shown in FIG. 5, one embodiment of an RFID Tracking System 300 of the present invention includes an RFID Reader 312 in communication with a computing device server 340. RFID Reader 312 is configured to receive signals from an RFID tag 310 and to transmit signals to the RFID tag 310. The server 340 is in communication with a database 320. Asset identification and maintenance and warranty information data 322 is stored in the database 320. The server 340 is selectively in communication with a network 330. Software executing on the server retrieves, displays and updates the data. The system 300 further includes software executing on the server for receiving a request from an End User for at least a portion of the data 322. Software executing on the server retrieves data 322 from the database 320 in response to the request. Software executing on the server transmits the retrieved data in accordance with the request.

As further shown in FIG. 5, an exemplary embodiment of system 300 is configured to securely generate, receive, store, catalog, update, provide relatively easy access to and/or transmit data 322 between and among End Users and other authorized users and/or administrators of the system in addition interface with external systems 332 for the purpose of exchanging data. The server 340 includes a central processing unit (CPU) 341, memory 342 that can include random access memory (RAM), read only memory (ROM), one or more data storage devices 344 such as a hard drive (HD) and the like, an input/output controller (I/O CNTRL) 346 operatively coupled to input and output devices 347 and 348, such as a keyboard, mouse, light pen or other pointing device, a document, card or other medium reader or scanner, a printer, a monitor or other display device for facilitating input to and output from the system of data and information, and an electronic communication apparatus (COMMS) 350 for communicating, with the network 330 such as, for example, the Internet, an intranet, an extranet, or like distributed communication platform connecting computing devices over wired and/or wireless connections. In one embodiment, system 300 is configured to interface with an inventory management system for inventory control and real time financial reporting.

It should be appreciated that the term server generally refers to one or more computing devices for use with the present invention. The server may comprise, for example, a standalone computing device and/or two or more computing devices operatively connected and functioning together to perform computer implemented functions as described herein.

The RFID tag 10 is permanently molded into the connector, housing, shroud, etc., to insure long-term uninterrupted use. Molding the RFID tag 10 within the electrical asset component insures the RFID tag 10 is not removed or damaged during use in rugged environments. Maintaining data within or in conjunction with the RFID tag 10 provides an ability to track electrical assets as they are passed from owner to owner or from lessee to lessee as well as the ability to reliably track such data for the longer periods required by LED products. Maintaining data within or in conjunction with the RFID tag 10 provides the ability to track circuit locations on airfields which can be challenging over time due to multiple modifications and resource turnover. All data collected over time for all applications described above can be used to determine usage, follow trends, and build location data of the respective electrical asset. Moreover, maintaining data within or in conjunction with the RFID tag 10 provides the ability to store data for multiple users such as for example from the manufacturer, to the lessee, to the lessor, to the end user. Each field of data stored within the RFID tag 10 can be locked per user and protected over time.

Each RFID tag 10 molded into an electrical asset, connector or other housing is rugged and made to endure the conditions of the rugged environments in which are intended to operate and as described above. In addition, the operating temperature ranges of certain electrical assets having the RFID tag 10 disposed therein exceed temperatures required for the molding process. The RFID tag 10 requires no internal power support; such RFID tags 10 are powered by the reader or scanner of the RFID tag 10. The expected life cycle or tag lifetime of each RFID tag 10 is greater than fifty (50) years including handling in excess of 100,000 read/write transmissions or transactions. In one embodiment, the RFID tag 10 comprises an ultra high frequency tag.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A Radio Frequency Identification (“RFID”) tracking system comprising:
an electrical connector; and
an RFID transponder disposed within the connector, the transponder configured to transmit a first signal to a transmitting and receiving device and receive a second signal from the transmitting and receiving device.

2. The RFID tracking system of claim 1, further comprising:
the RFID transponder molded within the connector below an exterior surface of the connector.

3. The RFID tracking system of claim 1, further comprising:
a metallic foil disposed on a back side of the RFID transponder.

4. The RFID tracking system of claim 1, further comprising:
a portable adaptive device having a processor and customizable interface enabled with an application configured for transmitting and receiving to and from the RFID transponder.

5. A method for identifying an electrical asset and managing maintenance and warranty information of the electrical asset, the method comprising:
imbedding an RFID transponder in a connector in communication with an electronic device;
transmitting a first signal to the imbedded RFID transponder; and
receiving a second signal from the RFID transponder.

6. The method for identifying an electrical asset and managing maintenance and warranty information of the electrical asset of claim 5, further comprising:
molding the RFID transponder within a connector below an exterior surface of the connector, the connector in electrical communication with the electrical asset.

7. The method for identifying an electrical asset and managing maintenance and warranty information of the electrical asset of claim 6, further comprising:
positioning a metallic foil on a back side of the RFID transponder.

8. The method for identifying an electrical asset and managing maintenance and warranty information of the electrical asset of claim 6, further comprising:
providing a portable adaptive device having a processor and customizable interface enabled with an application configured for transmitting and receiving to and from the RFID transponder.
